(19) United States
(12) Patent Application Publication
(10) Pub. No.: US 2003/0091413 A1
(43) Pub. Date: May 15, 2003

(54) Object retention in a rotatable carousel

(76) Inventor: Robin P. Yergenson, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/044,684

(22) Filed: Nov. 9, 2001

(51) Int. Cl. B65G 1/00

(52) U.S. Cl. 414/331.02; 414/800; 211/1.52

(57) ABSTRACT

An object retention system secures an object in a rotatable carousel. The rotatable carousel has an axis of rotation. A latching hub is mounted within the rotatable carousel about the axis of rotation. The object has a latch reciprocal configured to mate with the latching hub. Either the latching hub includes a prominence and the latch reciprocal has a depression formed therein to receive the prominence or the latch reciprocal includes a prominence and the latching hub has a depression formed therein to receive the prominence. At least one retainer is positioned adjacent the object within the rotatable carousel. Each retainer is configured to maintain contact between the latch reciprocal and the latching hub. Either each retainer or the latching hub is springable to permit insertion and removal of the container.

### FIELD OF THE INVENTION

This invention relates in general to object retention in a rotatable carousel systems and, more particularly, to securing an object to a latching hub in a rotatable carousel.

### BACKGROUND OF THE INVENTION

Often, objects are secured within a rotatable carousel. For example, color some color laser printers have a rotating carousel for toner cartridges. Each toner cartridge in the carousel has toner of a different color than each other cartridge in the carousel. The carousel rotates both to allow user access to each cartridge and to position each cartridge for use during printing. Each cartridge is secured within the rotatable carousel.

Object retention systems for rotatable carousels traditionally utilize multiple latches to secure objects within the rotatable carousel. Typically, the latches are located one on each end of the object. An example of a typical latching in a color laser printer system includes a rod mounted at each end of the object. The rods are latched into notches located on each side of the carousel.

Conventional object retention systems produce considerable installation problems. In order for the rotatable carousel to rotate, all of the latching features on the objects must be properly engaged. If any latching feature is not properly engaged, the rotatable carousel jams. When one of the latching features engages, the installer senses a positive tactile feedback. However, with more than one latching feature, often the positive tactile feedback leads the installer to incorrectly believe that all of the latching features are engaged. This common installation error results in rotatable carousel jams.

In addition, conventional object retention systems often require the installer to rotate and translate the object in order to properly engage the multiple latching features. The rotation and translation movement of the installer often adds to the difficulty of a proper installation.

### SUMMARY OF THE INVENTION

According to principles of the present invention, securing an object in a rotatable carousel is accomplished by an object retention system. The container retention system utilizes a latching hub to secure at least one object. The latching hub is mounted within the rotatable carousel about the axis of rotation. Each object has a latch reciprocal configured to mate with the latching hub. The mating of the latching hub and the latch reciprocal secures the object within the rotatable carousel.

According to further principles of the present invention, at least one retainer is positioned within the rotatable carousel. The retainer is positioned adjacent the object. The retainer is configured to maintain contact between one of the latch reciprocals and the latching hub.

According to further principles of the present invention, either the latching hub includes a prominence and the latch reciprocal has a depression formed therein to receive the prominence or the latch reciprocal includes a prominence and the latching hub has a depression formed therein to receive the prominence.

According to further principles of the present invention, the retainer or the latching hub is springable to permit insertion and removal of the object.

### DESCRIPTION OF THE DRAWINGS

FIG. 1 is a cross section view of one embodiment of the system of the present invention for retaining an object on a rotatable carousel.

FIG. 2 illustrates the system of FIG. 1 with an alternate embodiment of the latching hub and latch reciprocal.

FIG. 3 is an isometric view of the system of FIG. 1 showing the object interfacing with the retainer and the latching hub.

FIG. 4 is an illustration of one embodiment of the system of FIG. 1 wherein the latching hub extends only partway across the object.

FIG. 5 is a flow chart illustrating one embodiment of the method of the present invention for retaining an object on a rotatable carousel.

### DETAILED DESCRIPTION OF THE INVENTION

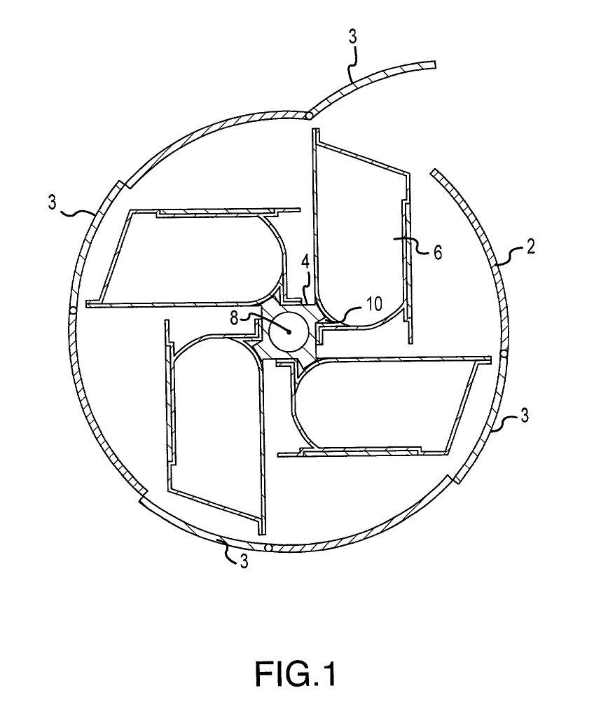

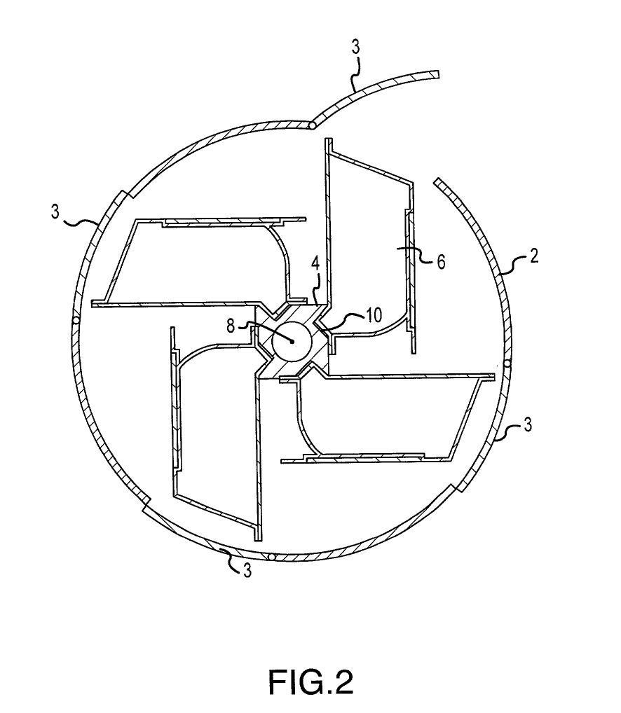

Illustrated in FIG. 1 are a rotatable carousel 2 with door 3, latching hub 4, and an object 6. Rotatable carousel 2 is any type of carousel that holds at least one object and rotates. The interior of rotatable carousel 2 is accessed through at least one door 3. Although FIGS. 1 and 2 illustrate four objects 6 within rotatable carousel 2, any number of objects 6 may be used. An example of a rotatable carousel 2 is a rotatable carousel for holding toner cartridges in a laser printer or copier.

Rotatable carousel 2 further has an axis of rotation 8. Latching hub 4 is mounted about axis of rotation 8 of rotatable carousel 2. In one embodiment, latching hub 4 is mounted on a shaft centered within rotatable carousel 2 and aligned with the axis of rotation 8.

Object 6 is any type of object that is secured into rotatable carousel 2. Examples of objects are toner cartridges, ink cartridges and electrical batteries.

Object 6 has a latch reciprocal 10. Latch reciprocal 10 mates with latching hub 4. Latching hub 4 and latch reciprocal 10 have any shape or size suitable for engaging and mating with each other.

FIGS. 1 and 2 illustrate different embodiments of latching hub 4 and latch reciprocal 8 mating. In one embodiment, as illustrated in FIG. 1, latching hub 4 includes a prominence. Latch reciprocal 10 has a depression formed therein for receiving the prominence of latching hub 4. In an alternate embodiment, illustrated in FIG. 2, latch reciprocal 10 includes a prominence. Latching hub 4 has a depression formed therein for receiving the prominence of latch reciprocal 10.

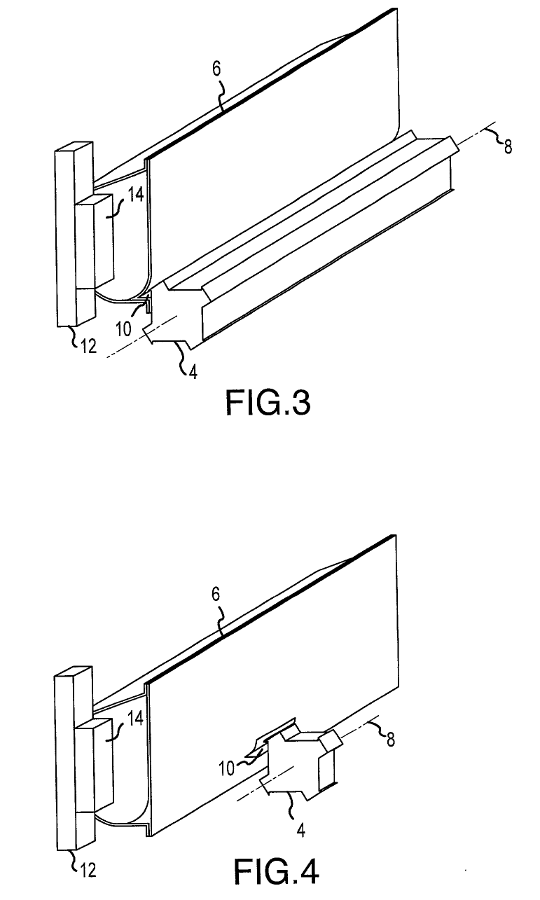

Latching hub 4 mates with latch reciprocal 8 at any point on object 6. FIGS. 3 and 4 illustrate further embodiments of latching hub 4 and latch reciprocal 10. In one embodiment, as illustrated in FIG. 3, latching hub 4 extends the entire length of container 6. In this embodiment, latching hub 4 is coextensive with object 6. In an alternate embodiment, as illustrated in FIG. 6, latching hub 4 mates with latch reciprocal 10 at the mid-point of the length of object 6, between the ends of object 6.

FIGS. 3 and 4 additionally illustrate retainer 12. Retainer 12 is a device or apparatus configured to maintain contact between latch reciprocal 10 and latching hub 4.

In one embodiment, retainer 12 includes a extension 14 of a protrusion attached to rotatable carousel 2. Retainer 12 abuts an object 6 to maintain contact between latching hub 4 and latch reciprocal 8.

In one embodiment, retainer 12 is rigid and latching hub 4 is springable to permit insertion and removal of object 6. In an alternate embodiment, latching hub 4 is rigid and retainer 12 is springable to permit insertion and removal of object 6.

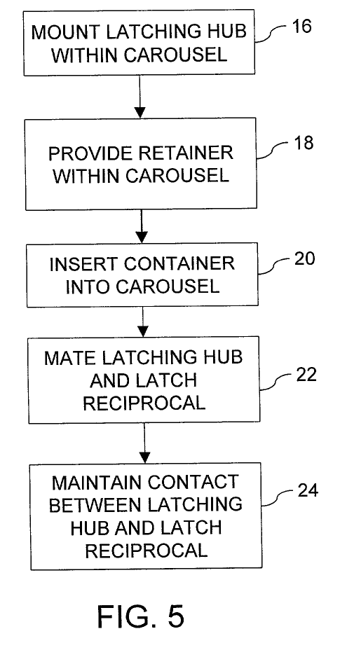

FIG. 5 is a flow chart representing steps of one embodiment of the present invention. Although the steps represented in FIG. 4 are presented in a specific order, the present invention encompasses variations in the order of steps. Furthermore, additional steps may be executed between the steps illustrated in FIG. 4 without departing from the scope of the present invention.

Latching hub 4 is mounted 16 within rotatable carousel 2. Rotatable carousel 2 provides 18 a retainer 12. Object 6 is inserted 20 into rotatable carousel 2. Latching hub 4 mates 22 with latch reciprocal 10. In one embodiment, object 6 provides a prominence forming latch reciprocal 10. A depression is formed on latching hub 4. The depression formed on latching hub 4 mates 22 with the prominence on latch reciprocal 10. In an alternate embodiment, latching hub 4 provides a prominence. A depression is formed on latch reciprocal 10. The depression formed on latch reciprocal mates 22 with the prominence on latching hub 4. Retainer 12 maintains 24 contact between latching hub 4 and latch reciprocal 10.

In one embodiment, when object 6 is inserted 20 into rotatable carousel 2, object 6 displaces retainer 12. This displacement permits latch reciprocal 16 to partially bypass latching hub 4 to allow for proper seating of object 6. Once object 6 is properly seated, retainer 12 returns to lock latching hub 4 against latch reciprocal 10. This locking serves to maintain 24 contact between latching hub 4 and latch reciprocal 10. To remove object 6, object 6 similarly displaces retainer 12 to permit object 6 to bypass latching hub 4 and exit rotatable carousel 2.

In an alternate embodiment, insertion 20 of object 6 displaces latching hub 4. This displacement permits object 6 to partially bypass latching hub 4 which allows for proper seating of object 6. Once object 6 is properly seated, latching hub 4 returns to lock latch reciprocal 10 against latching hub 4.

Providing latching hub 4 reduces the need for multiple latching features to retain object 6 within rotatable carousel 2. Reducing the need for multiple latching features reduces the possibility of improper installation and removal.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. An object retention system for securing an object in a rotatable carousel having an axis of rotation, the system comprising:
(a) a latching hub mounted within the rotatable carousel about the axis of rotation;
(b) at least one object within the rotatable carousel, each object having a latch reciprocal configured to mate with the latching hub; and,
(c) at least one retainer adjacent each object, each retainer configured to maintain contact between one of the latch reciprocals and the latching hub.

2. The system of claim 1 wherein:
(a) the latching hub includes at least one prominence; and
(b) each latch reciprocal has a depression formed therein for receiving one of the prominences of the latching hub.

3. The system of claim 1 wherein:
(a) each latch reciprocal includes a prominence; and
(b) the latching hub has at least one depression formed therein for receiving the prominence of each latch reciprocal.

4. The system of claim 1 wherein each retainer is springable to permit insertion and removal of each object.

5. The system of claim 1 wherein the latching hub is springable to permit insertion and removal of each object.

6. The system of claim 1 wherein the latching hub is substantially coextensive with each object.

7. The system of claim 1 wherein each object includes first and second ends and wherein the latch reciprocal of each object is positioned centrally between the first and second ends of each object.

8. A method for securing an object in a rotatable carousel having an axis of rotation, the method comprising:
(a) mounting a latching hub within the rotatable carousel about the axis of rotation;
(b) providing a retainer within the rotatable carousel;
(c) inserting an object, having a latch reciprocal, into the rotatable carousel;
(d) mating the latch reciprocal with the latching hub; and,
(e) the retainer maintaining contact between the latch reciprocal and the latching hub.

9. The method of claim 8 further including:
(a) providing the latching hub with a prominence; and
(b) forming a depression in the latch reciprocal for receiving the prominence of the latching hub.

10. The method of claim 8 further including:
(a) providing each latch reciprocal with a prominence; and
(b) forming a depression in the latching hub for receiving the prominence of the latch reciprocal.

11. The method of claim 8 wherein inserting the object includes:
(a) the object displacing the retainer, permitting the latch reciprocal to partially bypass the latching hub;
(b) the retainer returning to lock the latching hub against the latch reciprocal.

12. The method of claim 8 wherein inserting the object includes:
(a) displacing the latching hub, permitting the latch reciprocal to partially bypass the latching hub;
(b) the latching hub returning to lock the latching hub against the latching reciprocal.

13. An object retention system for retaining an object on a rotatable carousel, the system comprising:
(a) a rotatable carousel having an axis of rotation;
(b) a latching hub mounted within the rotatable carousel about the axis of rotation;
(c) an object within the rotatable carousel and having a latch reciprocal and a stop, the latch reciprocal configured to mate with the latching hub; and,
(d) at least one retainer mounted within the carousel adjacent the stop, each retainer configured to maintain contact between the latch reciprocal and the latching hub.

14. The system of claim 13 wherein:
(a) the latching hub includes a prominence; and
(b) the latch reciprocal has a depression formed therein for receiving the prominence of the latching hub.

15. The system of claim 13 wherein:
(a) the latch reciprocal includes a prominence; and
(b) the latching hub has a depression formed therein for receiving the prominence of the latch reciprocal.

16. The system of claim 13 wherein each retainer is springable to permit insertion and removal of each object.

17. The system of claim 13 wherein the latching hub is springable to permit insertion and removal of each object.

18. The system of claim 13 wherein the latching hub is substantially coextensive with the object.

19. The system of claim 13 wherein the object includes first and second ends and wherein the latch reciprocal is positioned centrally between the first and second ends of the object.
